(19) United States
(12) Patent Application Publication
(10) Pub. No.: US 2008/0259771 A1
(43) Pub. Date: Oct. 23, 2008

(54) Optical Pickup Device

(75) Inventor: Ryotaro NAKAGAWA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/834,309

(22) Filed: Aug. 6, 2007

(30) Foreign Application Priority Data
Sep. 27, 2006 (JP) 2006-262802

(51) Int. Cl. G11B 7/00

(52) U.S. Cl. 369/112.23

(57) ABSTRACT

An optical pickup device comprises a lens holder to hold an objective lens for irradiating a laser beam onto an optical disc; outer and inner circumferential side wires fixed at one ends thereof to outer and inner circumferential sides of the lens holder and extending substantially in parallel to the optical disc; a suspension holder for suspending and supporting the other ends of the outer and inner wires to cantilever the lens holder; and a magnetic drive circuit for driving the lens holder in a focusing direction and a tracking direction. The outer wires have an effective length longer than that of the inner wires. This makes it possible to tilt the objective lens so as to compensate the tilt of the optical disc, if any, at the time of recording and reproduction, thereby reducing jitter and improving recording and reproduction performance of the optical pickup device with simple structure.

### BACKGROUND OF THE INVENTION

1. Field of the Invention

The present invention relates to an optical pickup device, and particularly an optical pickup device having a tilt compensation function to compensate for tilt of an optical disc.

2. Description of the Related Art

An optical disc such as DVD (Digital Versatile Disc) is often used as a recording medium because recording tracks of the optical disc can be rapidly accessed by an optical pickup device movably mounted in an optical disc drive. In such an optical pickup device, an objective lens for irradiating a laser beam onto the optical disc is driven in the direction of the optical axis of the objective lens (focusing direction) and in the radial direction of the optical disc (tracking direction), respectively, for tracking control and focus control, or more specifically to focus and track the laser beam on a recording track on the optical disc. The optical disc is primarily assumed to have a flat signal recording surface (for recording tracks) in a horizontal position parallel to a horizontal plane (imaginary horizontal plane) in an optical disc drive.

Thus, for focus control, the objective lens of the optical pickup device is primarily designed to move substantially perpendicular to the horizontal plane so as to focus a light spot on a recording track on the signal recording surface of the optical disc. However, actually, the optical disc is often tilted to the horizontal plane in the optical disc drive (the optical disc is e.g. spaced apart from the horizontal plane at an outer circumference thereof) e.g. due to a deformation of the optical disc. Furthermore, the objective lens itself of the optical pickup device may not be perpendicular to the horizontal plane. This may cause the signal recording surface of the optical disc to be not parallel and tilted at a tilt angle to a plane perpendicular to the optical axis of the objective lens. Note that this relative tilt between the signal recording surface and the plane perpendicular to the optical axis of the objective lens is sometimes referred to as skew or radial skew.

For example, when the optical disc is tilted to the horizontal plane to cause the outermost circumference thereof to be spaced from the horizontal plane by ±0.5 mm, the tilt angle of the optical disc at the outermost circumference becomes ±25 minutes (one degree=60 minutes). This is generally shown in FIG. 9A which is a schematic view for explaining a relative tilt between an objective lens 100 and an optical disc 101 in a conventional optical pickup device where the objective lens 100 is not tilted to the horizontal plane. In FIG. 9A (also in FIG. 9B), the left (leftmost) and right (rightmost) ends of the optical disc 101 are the outer (outermost) circumferential end and the center of the optical disc 101, respectively. As shown by the solid line in FIG. 9A, the center or optical axis of the objective lens 100 is substantially perpendicular to a signal recording surface of the optical disc 101 in state B where the optical disc 101 is on, or not tilted to, the horizontal plane.

In contrast, the optical disc 101 is tilted to the objective lens 100 at a tilt angle θ1 in both state A and state C where the optical disc 101 is positioned above and below the horizontal plane at the outer (outermost) circumference thereof, respectively. The tilt angle θ1 in FIG. 9A is assumed to be 20 minutes. It is to be noted that the polarity of the tilt angle θ1 of the optical disc 101 relative to the horizontal plane is defined based on the position of the outer (outermost) circumference of the optical disc 101, such that when the outer circumference of the optical disc 101 is higher than an inner circumference of the optical disc 101 relative to the horizontal plane, the tilt angle θ1 is positive, and vice versa. Accordingly, the polarity of the tilt angle θ1 in state A is defined as positive (+20 minutes), while the polarity of the tilt angle θ1 in state C is defined as negative (−20 minutes).

Next, FIG. 9B is a schematic view for explaining the relative tilt between the objective lens 100 and the optical disc 101 with possible variations in tilt of the objective lens 100 to the horizontal plane. The objective lens 100 may possibly be tilted to the horizontal plane e.g. due to manufacturing variations. Referring to FIG. 9B, in an extreme case, the objective lens 100 may not be tilted to the horizontal plane as in state B, or, in the other extreme case, may be tilted to the horizontal plane at a negative tilt angle θ2 as in state A or at a positive tilt angle θ2 as in state C. Note that the polarity of the tilt angle θ2 of the objective lens 100 here is defined similarly as in the optical disc 101.

That is, when an outer circumferential side (left side in FIG. 9B) of the objective lens 100 is higher than an inner circumferential side (right side in FIG. 9B) of the objective lens 100 relative to the horizontal plane, the then tilt angle θ2 of the objective lens 100 is defined as positive, and vice versa. The tilt angle θ2 in FIG. 9B is also assumed to be 20 minutes at maximum. Thus, in extreme cases, the relative tilt angle between the optical disc 101 and the objective lens 100 may be 40 minutes. The relationship among these disc tilt angle α 1, the lens tilt angle θ2 and the relative tilt angle between the optical disc 101 and the objective lens 100 in states A, B and C is summarized in Table 1 below.

TABLE 1

| State | Disc Tilt Angle θ1 | Lens Tilt Angle θ2 | Relative Tilt Angle |
|---|---|---|---|
| A | +20 minutes | −20 minutes | 40 minutes |
| B | 0 minutes | 0 minutes | 0 minutes |
| C | −20 minutes | +20 minutes | 40 minutes |

The disc tilt may cause an erroneous operation. As apparent from the above description, if the lens tilt angle θ2 is 0 minutes, the relative tilt angle between the optical disc 101 and the objective lens 100 is equal to the disc tilt angle θ2, which is +20 minutes in state A and −20 minutes in state C. The relative tilt angle of +20 minutes or −20 minutes may cause the shape of the light spot on a signal recording surface of the optical disc 101 to be elliptical rather than circular. This, in turn, causes jitter and may prevent the optical pickup device from accurately reading or reproducing information signals (including image data) from the signal recording surface with the information signals recorded thereon, and accurately writing or recording information signals on the signal recording surface with no information signals recorded thereon.

If the lens tilt angle θ2 is not 0 minutes (or is tilted to the horizontal plane) and varies e.g. in a range of +20 minutes, the relative tilt angle between the optical disc 101 and the objective lens 100 becomes 40 minutes (maximum sum of ±20 minutes of θ1 and ±20 minutes of θ2) at maximum or in the worst case as in state A and state C shown in FIG. 9B, in which the optical disc 101 and the objective lens 100 are tilted in opposite directions to each other. This causes the shape of the light spot on the signal recording surface to be more elliptical than without the lens tilt. This, in turn, increases jitter, and may make it impossible to write (record) and read (reproduce) information signals to and from the optical disc 101.

There are conventional optical pickup devices using a lens holder for holding or driving an objective lens for tracking or focusing. For example, Japanese Laid-open Patent Publication 2004-178775 discloses an optical pickup device with a tilt compensation mechanism. This optical pickup device has a lens holder for holding an objective lens, a suspension wire (hereafter referred to simply as “wire”) for suspending the lens holder at its end, a wire holder for holding the other end of the wire, and a magnetic drive circuit for driving the lens holder in focus and tracking directions. The wire is driven in its lengthwise direction to correct tilt of the optical axis of the objective lens to the signal recording surface of an optical disc which may be tilted relative to an imaginary horizontal plane. However, this optical pickup device is disadvantageous in that it additionally requires a magnet, a winding, a driving power supply, and the like to drive the wire in its lengthwise direction for the purpose of providing the tilt compensation mechanism, causing problems of complex structure and high cost.

Japanese Laid-open Patent Publication 2003-308621 discloses an optical pickup device having a lens holder and a suspension base for correcting the tilt of an objective lens to an optical disc. In this optical pickup device, each of the lens holder and the suspension base has four wire supporting members (namely upper and lower members on an inner side of an optical disc, and corresponding upper and lower members on an outer side of the optical disc) for supporting four wires each between a horizontal pair of wire supporting members of the suspension base and the lens holder (namely each between upper inner, lower inner, upper outer and lower outer pairs of wire supporting members of the lens holder and the suspension base).

Thus, each of the lens holder and the suspension base has a vertical pair of inner wire supporting members provided at upper and lower positions thereof on the inner side of the optical disc as well as a vertical pair of outer wire supporting members provided at upper and lower positions thereof on the outer side of the optical disc, thereby forming four vertical pairs of wire supporting members. In this optical pickup device, the distance between the upper and the lower positions of the wire supporting members of at least one of the vertical pairs is set different from that of the other vertical pairs. At the same time, at least one of the four wires is supported to be not parallel to the other wires. This optical pickup device is also disadvantageous in that it has a complex structure and is difficult to manufacture because of the asymmetric arrangement of the four wire supporting members, and the non-parallel arrangement of the four wires.

Japanese Laid-open Patent Publication 2005-107145 discloses an optical pickup device having a lens holder for holding an objective lens and at least two pairs of wires for supporting the objective lens, each pair of which clamp the lens holder in a tracking direction. In this optical pickup device, the wires positioned farther from the objective lens are less likely to bend in the tracking direction that those positioned closer to the objective lens. Furthermore, Japanese Laid-open Patent Publication 2005-18837 discloses an optical pickup device having a lens holder for holding an objective lens and three wires (upper, middle and lower wires in order from closest to farthest from an optical disc) provided on each of both sides of the lens holder. In this optical pickup device, at least one of the two middle wires has a spring constant different from those of the other wires. However, none of these two patent publications disclose an optical pickup device in which an objective lens or lens holder is driven for correcting the tilt of the objective lens relative to an optical disc when the objective lens is driven in a focusing direction.

### SUMMARY OF THE INVENTION

An object of the present invention is to provide an optical pickup device which, with a simple structure, can reduce tilt between an optical disc and an objective lens when recording (writing) or reproducing (reading) information signals on or from the optical disc, thereby improving recording and reproduction performance of the optical pickup device.

According to a first aspect of the present invention, the object of the present invention is achieved by an optical pickup device comprising: an objective lens; a lens holder for holding the objective lens at a position facing a signal recording surface of an optical disc, the lens holder having an outer circumferential side and an inner circumferential side relative to the optical disc; a suspension wire (hereafter referred to as “outer wire”) fixed at one end thereof to the outer circumferential side of the lens holder and a suspension wire (hereafter referred to as “inner wire”) fixed at one end thereof to the inner circumferential side of the lens holder, the outer and inner wires extending substantially in parallel to the signal recording surface of the optical disc, a suspension holder for supporting the other ends of the outer and inner wires so as to cantilever the lens holder, and a magnetic drive circuit for driving the lens holder with the objective lens in a focusing direction. Therein, the outer wire has a longer effective length than that of the inner wire, whereby when the lens holder with the objective lens is moved in the focusing direction by the magnetic drive circuit, the movement of the lens holder causes the outer wire to move more than the inner wire so as to tilt the objective lens at a tilt angle corresponding to the amount of movement of the lens holder.

According to a second aspect of the present invention, the object of the present invention is achieved by an optical pickup device comprising: an objective lens; a lens holder for holding the objective lens at a position facing a signal recording surface of an optical disc, the lens holder having an outer circumferential side and an inner circumferential side relative to the optical disc; a suspension wire (hereafter referred to as “outer wire”) fixed at one end thereof to the outer circumferential side of the lens holder and a suspension wire (hereafter referred to as “inner wire”) fixed at one end thereof to the inner circumferential side of the lens holder, the outer and inner wires extending substantially in parallel to the signal recording surface of the optical disc, a suspension holder for supporting the other ends of the outer and inner wires so as to cantilever the lens holder, and a magnetic drive circuit for driving the lens holder with the objective lens in a focusing direction. Therein, the outer wire has a lower stiffness than the inner wire, whereby when the lens holder with the objective lens is moved in the focusing direction by the magnetic drive circuit, the movement of the lens holder causes the outer wire to move more than the inner wire so as to tilt the objective lens at a tilt angle corresponding to the amount of movement of the lens holder.

In the optical pickup device according to each of the first aspect and the second aspect of the present invention, the objective lens can be rotated or tilted at a tilt angle linked with the movement of the objective lens when the lens holder with the objective lens is moved in the focusing direction. This makes it possible to tilt the objective lens at an angle corresponding to a tilt, if any, of the optical disc, which is a desired DC tilt angle. Thus, with a simple structure, the optical pickup device can reduce or compensate tilt between the optical disc and the objective lens, so as to make and maintain the optical axis of the objective lens substantially perpendicular to the signal recording surface of the optical disc, when recording (writing) or reproducing (reading) information signals on or from the optical disc, thereby reducing jitter and improving recording and reproduction performance of the optical pickup device.

In the first aspect of the present invention, preferably, the one end of the outer wire fixed to the outer circumferential side of the lens holder is positioned at a position farther from the suspension holder than a position at which the one end of the inner wire fixed to the inner circumferential side of the lens holder is positioned. This facilitates the provision of the difference in effective length between the outer wire and the inner wire.

In the second aspect of the present invention, preferably, the outer wire is made of a material different from a material of which the inner wire is made. This facilitates the provision of the difference in stiffness between the outer wire and the inner wire.

In a further preferred mode of the second aspect of the present invention, the outer wire has an effective length substantially the same as that of the inner wire. In a still further preferred mode of the second aspect of the present invention, the one end of the outer wire fixed to the outer circumferential side of the lens holder and the one end of the inner wire fixed to the inner circumferential side of the lens holder are equidistant from the suspension holder. Advantages of these preferred modes are that conventional optical pickup devices may be able to be easily improved by simply changing the stiffness or material of suspension wires, and that the substantially same effective length of the outer and inner wires makes it possible to produce a tilt of the objective lens (desired DC tilt) with a good mechanical balance between the outer and inner circumferential sides of the lens holder, making it easier to maintain or restore the perpendicular relationship between the signal recording surface of the optical disc and the optical axis of the objective lens.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1A is a schematic partially cut-away perspective view of an optical disc drive on which an optical pickup device according to a first embodiment of the present invention with an optical disc is mounted;

FIG. 1B is a schematic side view of a main part of the optical disc drive for explaining a positional relationship between the optical pickup device and the optical disc;

FIG. 2 is a schematic perspective view of the optical pickup device according to the first aspect of the present invention;

FIG. 3 is a schematic perspective view of a lens holder and a suspension holder in the optical pickup device for holding and suspending the lens holder, and is used to explain the mechanism of suspension;

FIG. 4 is a schematic plan view of a main part of the optical pickup device of FIG. 2 for explaining e.g. the length relationship between outer and inner circumferential side wires;

FIG. 5A, FIG. 5B and FIG. 5C are schematic front views each of the lens holder with an objective lens and the outer and inner circumferential side wires relative to the optical disc in focus control in three different states, respectively;

FIG. 6 is a schematic front view of the objective lens relative to the optical disc in the focus control in the three different states, showing a relative tilt between the objective lens and the optical disc, including a disc tilt angle and a lens tilt angle;

FIG. 7 is a schematic perspective view of a lens holder and a suspension holder in the optical pickup device according to a second embodiment of the present invention for holding and suspending the lens holder, and is used to explain the mechanism of suspension;

FIG. 8 is a schematic plan view of a main part of the optical pickup device of FIG. 7 for explaining e.g. the length relationship between outer and inner circumferential side wires;

FIG. 9A is a schematic view for explaining a relative tilt between an objective lens and an optical disc in a conventional optical pickup device where the objective lens is not tilted, while FIG. 9B is a schematic view for explaining the relative tilt between the objective lens and the optical disc with possible variations in tilt of the objective lens to the horizontal plane.

### DESCRIPTION OF THE PREFERRED EMBODIMENTS

The best mode and preferred embodiments of the present invention will be described hereinafter with reference to the annexed drawings. Note that the specific embodiments described are not intended to cover the entire scope of the present invention, and hence the present invention is not limited to only the specific embodiments. Also note that like parts are designated by like reference numerals, characters or symbols throughout the drawings.

### First Embodiment

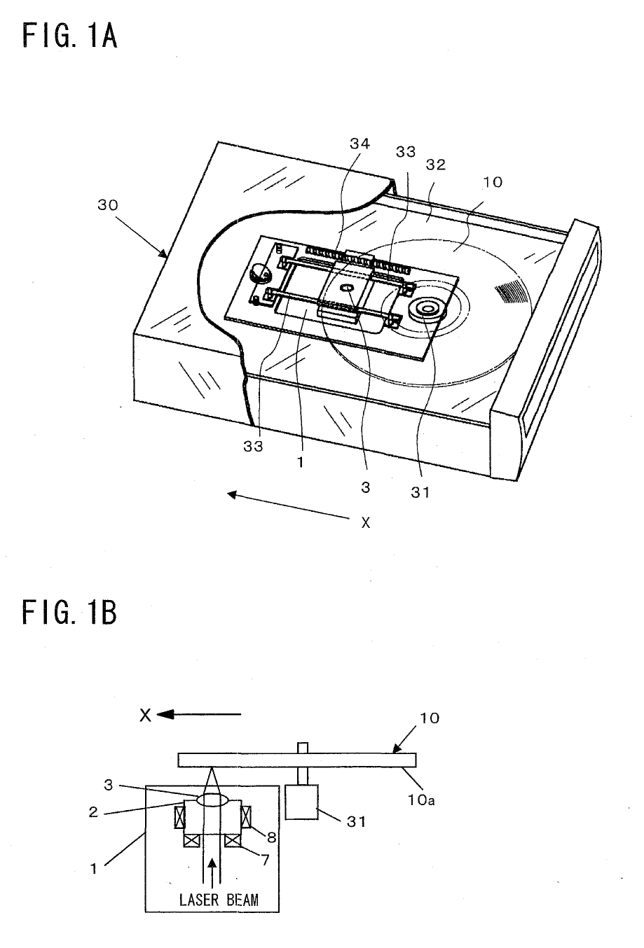

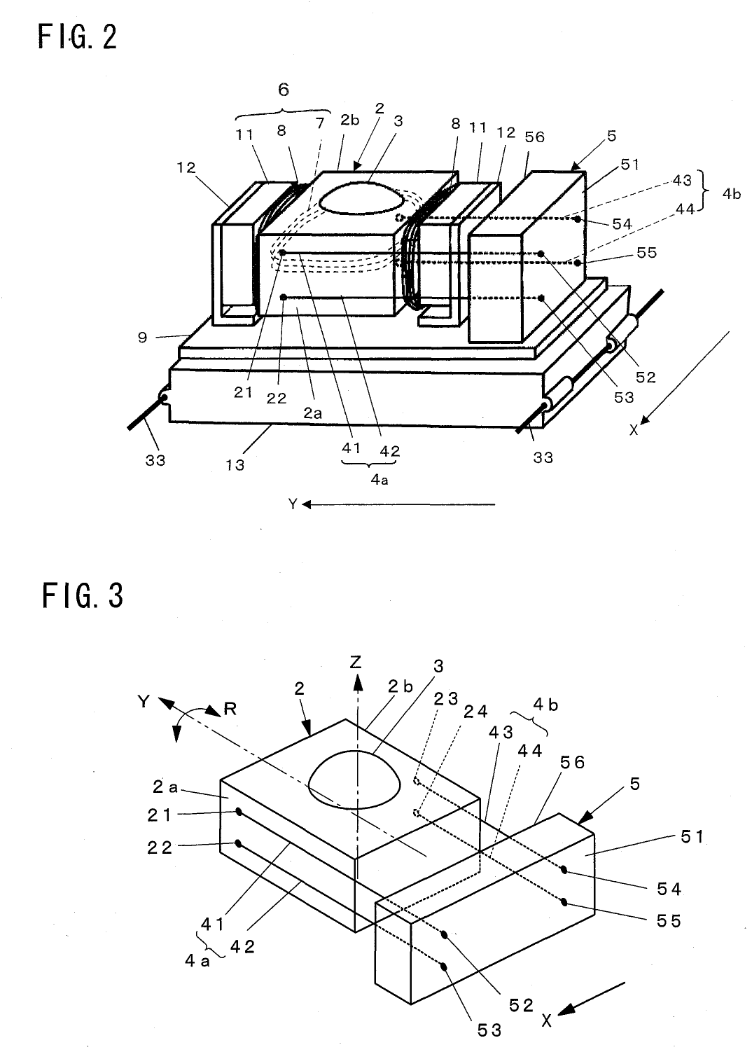

An optical pickup device 1 according to a first embodiment of the present invention will be described with reference to FIGS. 1A, 1B, 2, 3, 4, 5A, 5B, 5C and 6. The optical pickup device 1 guides a laser beam emitted from a laser diode to a signal recording surface of an optical recording medium through various optical components placed on a light path to record or reproduce information signals on or from the optical recording medium. FIG. 1A is a schematic partially cut-away perspective view of an optical disc drive 30 on which the optical pickup device 1 with an optical disc 10 for recording (writing) and reproducing (reading) information signals on and from the optical disc 10 is mounted, while FIG. 1B is a schematic side view of a main part of the optical disc drive 30 for explaining a positional relationship between the optical pickup device 1 and the optical disc 10. FIG. 2 is a schematic perspective view of the optical pickup device 1, while FIG. 3 is a schematic perspective view of a lens holder 2 and a suspension holder 5 in the optical pickup device 1 for holding and suspending the lens holder 2, and is used to explain the mechanism of suspension.

As shown in FIGS. 1A and 1B, the optical disc drive 30 has a chassis 32 having mounted thereon a turntable 31 for holding and rotating an optical disc 10 mounted thereon. The optical disc drive 30 slides the optical pickup device 1 of the present embodiment in a radial direction of the optical disc 10 (direction X shown in FIGS. 1A and 1B where the arrow points to an outer circumference of the optical disc 10). The optical pickup device 1 is supported by and slides on two slide shafts 33, and is driven by a screw shaft 34 to slide. The optical pickup device 1 comprises an objective lens 3 for irradiating a laser beam onto a signal recording surface 10a of the optical disc 10, in which the lens holder 2 has a focusing coil 7 and a tracking coil 8 mounted thereon. The optical pickup device 1 further comprises a lens holder 2 for holding the objective lens 3 at a position facing the signal recording surface 10a of the optical disc 10.

The optical pickup device 1 comprises in addition to the objective lens 3 and the lens holder 2: suspension wires (hereafter referred to simply as “wire(s)”) forming two outer circumferential side wires (hereafter referred to as “outer wires”) 4a (41, 42) in a pair and two inner circumferential side wires (hereafter referred to as “inner wires”) 4b (43, 44) in a pair; a suspension holder 5; a magnetic drive circuit 6; and other elements related to these elements. The lens holder 2 has an outer circumferential side 2a and an inner circumferential side 2b which are substantially parallel to each other, and are also substantially parallel to the major plane of the optical disc 10. The lens holder 2 holds the objective lens 3 at a position facing the signal recording surface 10a of the optical disc 10 and positioned between the outer and inner circumferential sides 2a, 2b. Here, the terms “outer circumferential side” (2a) and “inner circumferential side” (2b) of the lens holder (2) are used to mean sides of the lens holder (2) relative to the optical disc 10 in the optical pickup device 1 or the optical disc drive 30, such that the former side is farther from the center of the optical disc 10, while the latter side is closer to the center of the optical disc 10 in an arrangement where the two sides (2a, 2b) extend substantially perpendicular to the direction X in which the lens holder 2 (or housing 13) moves as will be described later.

The outer and inner wires 4a and 4b extend substantially in parallel to a later described base 9 and the signal recording surface 10a of the optical disc 10. One end of each of the outer wires 4a is fixed to the outer circumferential side 2a, while one end of each of the inner wires 4b is fixed to the inner circumferential side 2b of the lens holder 2. The other ends of the outer and inner wires 4a, 4b are fixed to the suspension holder 5 so as to allow the suspension holder 5 to cantilever or floatingly support the lens holder 5. Note that although not shown, the outer and inner wires 4a, 4b are electrically connected to the focusing coil 7 and the tracking coil 8 in a well-known manner to electrically drive these coils. Also note that although the present embodiment describes the use of two wires on each of the outer and inner circumferential sides 2a, 2b of the lens holder 2, the number of wires can be one or three or more on each side 2a, 2b.

The magnetic drive circuit 6 comprises: a focusing coil 7 and a tracking coil 8 mounted on the lens holder 2 for driving the lens holder 2 in a focusing direction and a tracking direction, respectively; and a pair of combinations of magnets 11 and yokes 12 fixed to a base 9 on both sides of the lens holder 2 in direction Y which is perpendicular to the direction X. The suspension holder 5 is also fixed to the base 9, which, in turn, is fixed to a housing 13 containing the optical components and so on. The housing 13 is supported by a pair of slide shafts 33 fixed to the optical drive 30 so as to be movable back and forth in the radial direction (direction X) of the optical disc 10. The focusing coil 7 is wound around the lens holder 2 such that the winding axis of the focusing coil 7 is parallel to, or substantially coincides with, the optical axis of the objective lens 3. In the focusing operation, the focusing coil 7 together with the lens holder 2 moves closer to or farther from the optical disc 10 in direction Z perpendicular to both directions X, Y, and can rotate or tilt by a small angle such as ±20 minutes in direction R clockwise or counterclockwise as seen in the direction Y as will be described later. On the other hand, the tracking coil 8 is provided on both sides of the lens holder 2 in the tracking direction (direction Y).

It will be described how the lens holder 2 is suspended or supported by the outer circumferential side wires 4a and inner circumferential side wires 4b. The wires 41, 42 of the outer wires 4a and the wires 43, 44 of the inner wires 4b have fixed ends 21, 22 and fixed ends 23, 24 at one ends thereof on the outer circumferential side 2a and the inner circumferential side 2b of the lens holder 2, respectively. The fixed ends 23, 24 are positioned substantially at a center on the inner circumferential side 2b between both ends of the lens holder 2 in the direction Y, while the fixed ends 21, 22 are positioned on the outer circumferential side 2a at a position farther from the suspension holder 5 than the center of the outer circumferential side 2 between both ends of the lens holder 2 in the direction Y. The wires 41, 42 of the outer wires 4a and the wires 43, 44 of the inner wires 4b extend through the suspension holder 5 via an internal surface (lens holder-facing surface) 56 of the suspension holder 5, and have fixed ends 52, 53 and fixed ends 54, 55 at the other ends thereof on an external surface 51 of the suspension holder 5. These fixed ends 52, 53, 54, 55 are electrically insulated from each other, and fixed by a fixing means (not shown) such as soldering to a circuit board provided on the external surface 51 of the suspension holder 5.

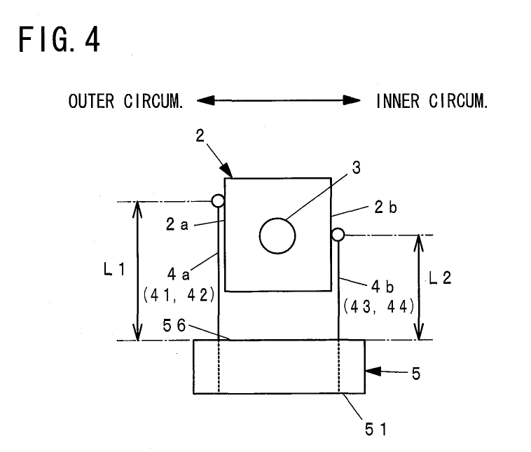

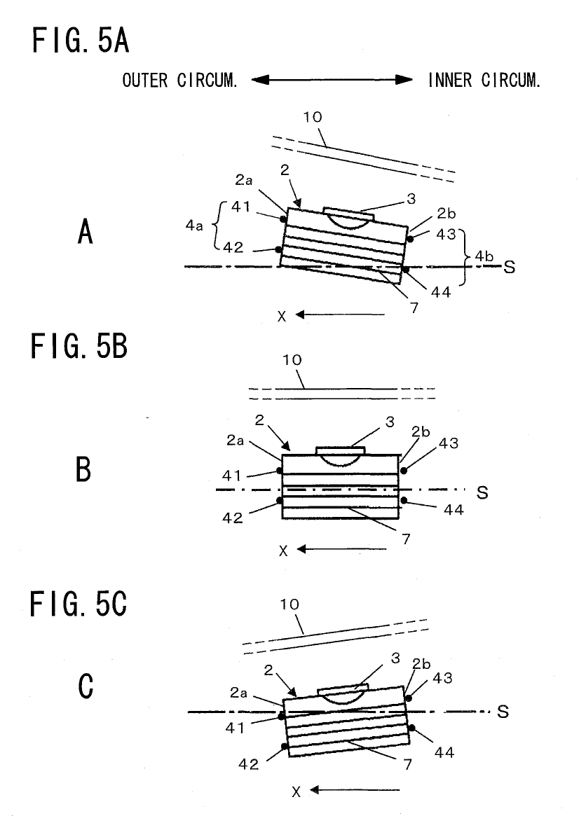

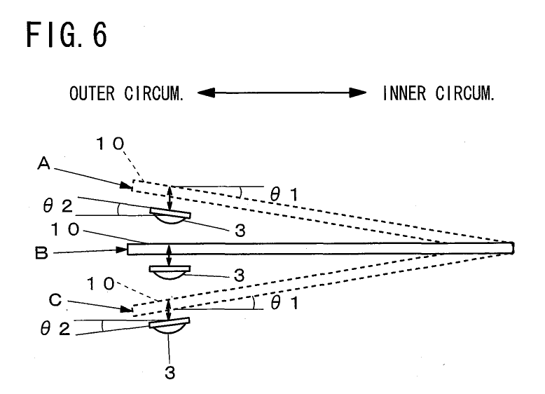

Referring now to FIG. 4 to FIG. 6, a length relationship between the outer and inner wires 4a, 4b as well as effects which the length relationship has on the operation of the optical pickup device 1 will be described. FIG. 4 is a schematic plan view of a main part of the optical pickup device 1 of FIG. 2 for explaining e.g. the length (effective length) relationship between the outer and inner wires 4a, 4b. FIG. 5A, FIG. 5B and FIG. 5C are schematic front views each of the lens holder 2 with an objective lens 3 and the outer and inner wires 4a (41, 42) and 4b (43, 44) relative to the optical disc 10 in focus control, respectively, in state A where the optical disc 10 is tilted with its outer circumference positioned above a horizontal plane (imaginary horizontal plane) S in the optical pickup device 1 (or in the optical disc drive 30), and in state B where the optical disc 10 is not tilted, and further in state C where the optical disc 10 is tilted with its outer circumference positioned below the horizontal plane S. On the other hand, FIG. 6 is a schematic front view of the objective lens 3 relative to the optical disc 10 in the focus control in states A, B and C, showing a relative tilt between the objective lens 3 and the optical disc 10, including a disc tilt angle θ1 and a lens tilt angle θ2 in states A and C.

In the present embodiment, all the outer and inner wires 4a, 4b (41, 42, 43, 44) are made of the same material with the same diameter and so on, namely obtained from the same wire, so that they have the same properties. As shown in FIG. 4, the outer wires 4a fixed at one ends thereof to the outer circumferential side 2a of the lens holder 2 have an effective length L1, while the inner wires 4b fixed at one ends thereof to the inner circumferential side 2b of the lens holder 2 have an effective length L2 which is different from the effective length L1. More specifically, in this case, the effective length L1 of the outer wires 4a is longer than the effective length L2 of the inner wires 4b, so that the fixed ends 21, 22 of the outer wires 4a (wires 41, 42) on the lens holder 2 are farther from the suspension holder 5 than the fixed ends 23, 24 of the inner wires 4b (wires 43, 44) on the lens holder 5.

Note here that the effective lengths L1, L2 of the outer and inner circumferential side wires 4a, 4b are lengths of the outer and inner wires 4a, 4b between the fixed ends on the lens holder 2 and the suspension holder 5, between which the outer and inner wires 4a, 4b can elastically deform. The essential fixed ends on the suspension holder 5 are present on the internal surface 56 at which the outer and inner wires 4a, 4b enter the suspension holder 5. Accordingly, as shown in FIG. 4, the effective length L1 of the outer wires 4a is the distance between the internal surface 56 of the suspension holder 5 and the fixed ends 21, 22 on the lens holder 2, while the effective length L2 of the inner wires 4b is the distance between the inner surface 56 of the suspension holder 5 and the fixed ends 23, 24 on the lens holder 2.

In the following, the operation of the optical pickup device 1, particularly the objective lens 3, will be described when the optical pickup device 1 is operated for recording or reproduction using the optical disc 10, either tilted or not tilted relative to the horizontal plane. Here, the effective length L1 of the outer wires 4a for suspending and supporting the outer circumferential side 2a of the lens holder 2 is different from (in this case longer than) the effective length L2 of the inner wires 4b for suspending and supporting the inner circumferential side 2b of the lens holder 2. Thus, the overall mobility of each of the outer wires 4a (41, 42) is higher than that of each of the inner wires 4b (43, 44).

Accordingly, when the lens holder 2 is driven and moved by the magnetic drive circuit 1 in the focusing direction, upward or downward in direction Z, the outer circumferential side 2a of the lens holder 2 is moved more in that direction (focusing direction) than the inner circumferential side 2b of the lens holder 2. This makes it possible to give a DC tilt to the objective lens 3. Here, the term “DC tilt” is used to mean a tilt angle (amount of tilt) which is relative to the horizontal plane in the optical pickup device 1, and which is an amount or angle corresponding to the amount of movement of the lens holder 2 driven by the magnetic drive circuit 1. This will be described in detail below with reference to FIG. 5A, FIG. 5B, FIG. 5C and FIG. 6.

Referring first to FIG. 5B, in state B (basic state) where the optical disc 10 is parallel to and not tilted to the horizontal plane S, the objective lens 3 is positioned at a predetermined distance (focusing distance) from the signal recording surface 10a of the optical disc 10, and the center axis (optical axis) of the objective lens 3 is substantially perpendicular to the signal recording surface 10a of the optical disc 10. Accordingly, in the focusing operation, the laser beam emitted from the objective lens 3 can be focused on the signal recording surface 10a without substantial movement of the lens holder 2 (objective lens 3) closer to or farther from the signal recording surface 10a so as to form a substantially circular beam spot on the signal recording surface 10a. Thus, a good quality image with low jitter can be recorded or reproduced on or from the signal recording surface 10a. Note that in FIG. 5B as well as FIGS. 5A and 5B, the horizontal plane S shown therein is at a basic fixed level. In the basic state B, the horizontal plane S passes through the middle of the lens holder 2 as seen in each of the figures.

On the other hand, in state A where the optical disc 10 is tilted to and positioned above the objective lens 3 such that an outer circumference of the optical disc 10 is positioned farther from the objective lens 3 than an inner circumference of the optical disc 10, the distance between the optical disc 10 and the objective lens 3 is initially longer than the predetermined distance (focusing distance). Thus, in the focusing operation, the lens holder 2 is driven by the magnetic drive circuit 6 to move and get closer to the signal recording surface 10a of the optical disc so as to maintain or restore the predetermined distance between the objective lens 3 and the signal recording surface 10a as shown in FIG. 5A, and so as to align and maintain the optical axis of the objective lens 3 to be substantially perpendicular to the signal recording surface 10a of the optical disc 10, thereby forming a substantially circular beam spot on the signal recording surface 10a.

At this time, the optical pickup device 1 of the present embodiment works to compensate the tilt of the optical disc 10. More specifically, the effective length L1 of the outer circumferential side wires 4a is longer than the effective length L2 of the inner circumferential side wires 4b, so that the overall mobility of the outer wires 4a is higher than that of the inner wires 4b. Accordingly, when the lens holder 2 (objective lens 3) moves upward to get closer to the optical disc 10, the outer wires 4a move more than the inner wires 4b, so that the outer circumferential side 2a of the lens holder 2 moves more than the inner circumferential side 2b of the lens holder 2 due to the difference in mobility between the outer and inner wires 4a and 4b fixed to the outer and inner circumferential sides 2a and 2b of the lens holder 2, respectively, thereby allowing the lens holder 2 or the objective lens 3 to slightly rotate or tilt clockwise in the direction R (rightward arrow) shown in FIG. 3 as seen in the direction Y, i.e. as seen in the front view of FIG. 5A.

Thus, the lens holder 2 or the objective lens 3 becomes tilted at a tilt angle corresponding to an amount of the movement of the lens holder 3 or the objective lens 3 (upward movement here), so as to compensate the tilt of the optical disc 10 as shown in FIG. 5A. This tilt of the lens holder 2 (objective lens 3) corresponding to the amount of the movement of the lens holder 2 (objective lens 3) is a DC tilt in the present specification. By appropriately selecting the effective lengths L1 and L2 of the outer and inner wires 4a and 4b, a desired DC tilt (namely a desired tilt of the lens holder 2 corresponding to the amount of movement of the lens holder 2 in the focusing direction) can be obtained, so as to compensate the tilt of the optical disc 10, that is to produce a DC tilt angle θ2 of the objective lens 3 which is substantially equal to a tilt angle θ1 of the optical disc 10 as will be described later with reference to FIG. 6.

On the other hand, in state C where the optical disc 10 is tilted to and positioned below the objective lens 3 such that an outer circumference of the optical disc 10 is positioned closer to the objective lens 3 than an inner circumference of the optical disc 10, the distance between the optical disc 10 and the objective lens 3 is initially shorter than the predetermined distance (focusing distance). Thus, in the focusing operation, the lens holder 2 is driven by the magnetic drive circuit 6 to move and get farther from the signal recording surface 10a of the optical disc so as to maintain or restore the predetermined distance between the objective lens 3 and the signal recording surface 10a as shown in FIG. 5C, and so as to align and maintain the optical axis of the objective lens 3 to be substantially perpendicular to the signal recording surface 10a of the optical disc 10, thereby forming a substantially circular beam spot on the signal recording surface 10a.

Also at this time, the optical pickup device 1 of the present embodiment works to compensate the tilt of the optical disc 10. More specifically, when the lens holder 2 (objective lens 3) moves downward to get farther the optical disc 10, the outer wires 4a move more than the inner wires 4b, based on the difference in mobility between the outer and inner wires 4a and 4b due to the difference between their effective lengths L1 and L2. Accordingly, the outer circumferential side 2a of the lens holder 2 moves more than the inner circumferential side 2b of the lens holder 2, thereby allowing the lens holder 2 or the objective lens 3 to slightly rotate or tilt counterclockwise in the direction R (leftward arrow) shown in FIG. 3 as seen in the direction Y, namely as seen in the front view of FIG. 5C.

Thus, the lens holder 2 or the objective lens 3 becomes tilted at a tilt angle corresponding to an amount of the movement of the lens holder 3 or the objective lens 3 (downward movement here), so as to compensate the tilt of the optical disc 10 as shown in FIG. 5C. Based on the effective lengths L1 and L2 (L1>L2) of the outer and inner wires 4a and 4b which are appropriately selected in FIG. 5A, a desired DC tilt (namely a desired tilt of the lens holder 2 corresponding to the amount of movement of the lens holder 2 in the focusing direction) can also be obtained here in FIG. 5C, so as to compensate the tilt of the optical disc 10, that is to produce a DC tilt angle θ2 of the objective lens 3 substantially equal to a tilt angle θ1 of the optical disc 10 also in the case of the tilt of the optical disc 10 which is opposite to the tilt in FIG. 5A.

As a result, not only in state B but also in states A and C, the relative tilt between the signal recording surface 10a of the optical disc 10 and the objective lens 3 can be reduced or compensated, making and maintaining the optical axis of the objective lens 3 substantially perpendicular to the signal recording surface 10a. Thus, with the simple structure, the optical pickup device 1 of the present embodiment can reduce or compensate the tilt (relative tilt) between the optical disc 10 and the objective lens 3 when recording (writing) or reproducing (reading) information signals on or from the optical disc 10, so as to reduce jitter and improve recording and reproduction performance of the optical pickup device 1, thereby enabling recording and reproduction of good quality images.

Note here that as the difference between the lengths L1 and L2 increases, the lens holder 2 or the objective lens 3 rotates more (for tilt), namely the sensitivity of the tilt rotation increases. In this respect, it may be preferable to reduce the length L2 of the inner wires 4b as much as possible. However, if the fixed ends 23, 24 of the inner wires 4b are positioned closer to the suspension holder 5 than the center on the inner circumferential side 2b between both ends of the lens holder 2 in direction Y, then the lens holder 2 might be undesirably rotated about axis Z in addition to the desirable rotation about axis Y (refer to FIG. 3). For this reason, preferably, the center on the inner circumferential side 2b is a limit position for the fixed ends 23, 24 to be positioned at. Thus, preferably, the fixed ends 23, 24 are positioned at the center on the inner circumferential side 2b, or other positions farther than such center from the suspension holder 5, but closer to the suspension holder 5 than the fixed positions 21, 22.

The relationship among the disc tilt angle θ1, the lens tilt angle θ2 and the relative tilt angle between the optical disc 10 and the objective lens 3 in states A, B and C shown in FIG. 6 is summarized in Table 2 below.

TABLE 2

| State | Disc Tilt Angle θ1 | Lens Tilt Angle θ2 | Relative Tilt Angle |
|---|---|---|---|
| A | +20 minutes | +20 minutes | 0 minutes |
| B | 0 minutes | 0 minutes | 0 minutes |
| C | −20 minutes | −20 minutes | 0 minutes |

The disc tilt angle θ1 in states A and C is assumed to be 20 minutes at maximum (+20 minutes or −20 minutes). Table 2 indicates that when the disc tilt angle θ1 takes the maximum value of +20 minutes or −20 minutes, the optical pickup device 1 according to the present embodiment can produce the lens tilt angle θ2 of the same (or substantially the same) maximum value of +20 minutes or −20 minutes so as to make the relative tilt angle zero (0 minutes), or compensate the disc tilt angle. Although not listed in Table 2, the disc tilt angle can similarly be compensated according to the present embodiment even when the disc tilt angle θ1 takes values other than (smaller than) the maximum value.

As described in the foregoing, the provision of the difference in length between the effective length L1 of the outer circumferential side wires 4a and the effective length L2 of the inner circumferential side wires 4b (L1>L2) in the optical pickup device 1 of the present embodiment makes it possible for the objective lens 3 to rotate or tilt clockwise or counterclockwise about axis Y which is perpendicular to the radial direction (axis X) of the optical disc 10, in which the rotation and the amount (angle) of rotation of the objective lens 3 are linked with the movement and the amount of movement of the objective lens 3 in the focusing direction. Thereby, a DC tilt of the objective lens 3 corresponding to the tilt (disc tilt) of the optical disc 10 can be automatically produced so as to automatically compensate the tilt of the optical disc 10. Thus, with the simple structure, the optical pickup device 1 of the present embodiment can reduce the tilt (relative tilt) between the optical disc 10 and the objective lens 3 when recording (writing) or reproducing (reading) information signals on or from the optical disc 10, so as to reduce jitter and improve recording and reproduction performance of the optical pickup device 1, thereby enabling recording and reproduction of good quality images.

### Second Embodiment

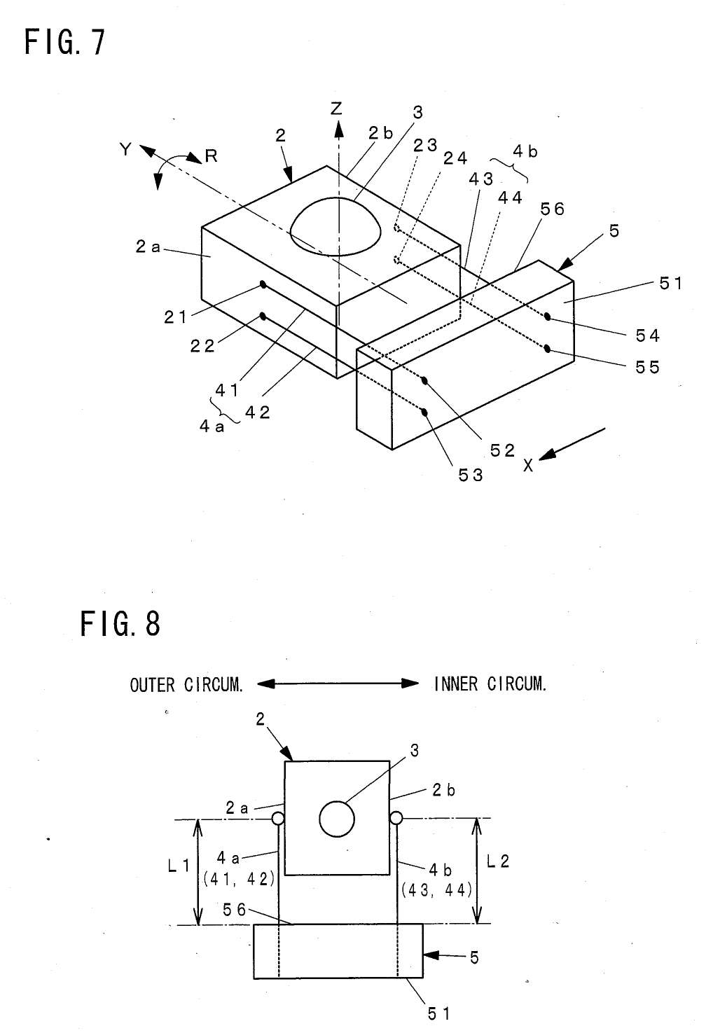

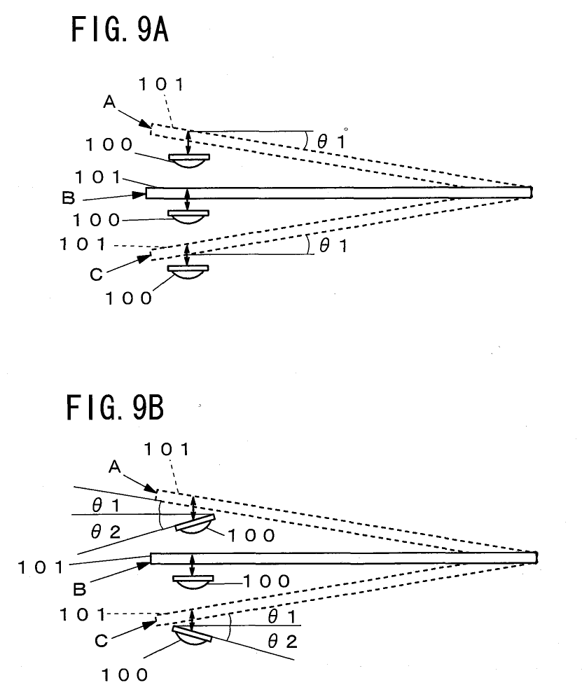

Referring to FIG. 7 and FIG. 8, an optical pickup device 1 according to a second embodiment of the present invention will be described. FIG. 7 is a schematic perspective view of a lens holder 2 and a suspension holder 5 in the optical pickup device 1 of the second embodiment for holding and suspending the lens holder 2, and is used to explain the mechanism of suspension. FIG. 8 is a schematic plan view of a main part of the optical pickup device 1 of FIG. 7 for explaining e.g. the length (effective length) relationship between outer and inner circumferential side wires 4a and 4b. The optical pickup device 1 of the second embodiment is the same as that of the first embodiment, except for the following points.

The optical pickup device 1 of the second embodiment has outer and inner circumferential side wires 4a and 4b having effective lengths L1 and L2, and fixed to the outer and inner circumferential sides 2a and 2b of the lens holder 2, in which, however, the effective length L1 is the same as the effective length L2. More specifically, the outer and inner wires 4a have fixed ends 21, 22 and fixed ends 23, 24 at one ends thereof on the outer and inner circumferential sides 2a and 2b of the lens holder 2, in which the fixed ends 21, 22 and the fixed ends 23, 24 are substantially equidistant from the suspension holder 5. The positions of the fixed ends 21, 22 and 23, 24 on the outer and inner sides 2a, 2b can be appropriately selected. In the present embodiment shown in FIGS. 7 and 8, the fixed ends 21 to 24 are positioned at substantially the center between both ends, in direction Y, of the lens holder 2. Furthermore, each of the outer wires 4a (41, 42) has a lower stiffness than each of the inner wires 4b (43, 44) e.g. by using different materials for the outer and inner wires 4a and 4b. More specifically, each of the outer wires 4a is made of a material different from and having a stiffness lower than a material of each of the inner wires 4b. Thus, the overall mobility of each of the outer wires 4a (41, 42) is higher than that of each of the inner wires 4b (43, 44).

In the optical pickup device 1 of the second embodiment, the effective length L1 of the outer wires 4a is substantially the same as the effective length L2 of the inner wires 4b, whereas the outer wires 4a has a lower stiffness than that of the inner wires 4b. Thus, when the lens holder 2 (objective lens 3) is moved in the focusing direction, i.e. upward or downward in direction Z, the outer wires 4a (hence outer circumferential side 2a of the lens holder 2) move more in the focusing direction than the inner wires 4b (hence inner circumferential side 2b of the lens holder 2), due to the difference in mobility between the outer and inner wires 4a and 4b fixed to the outer and inner circumferential sides 2a and 2b of the lens holder 2, respectively, so that the lens holder 2 rotates or tilts clockwise or counterclockwise about axis Y, respectively, at a tilt angle corresponding to the amount of movement of the lens holder 2 or the objective lens 3 in the focusing direction.

This makes it possible for the lens holder 2 or the objective lens 3 to be tilted (by the DC tilt) in the same direction as that of, and by an amount or angle corresponding to, the tilt of the optical disc 10 if any. By appropriately selecting the stiffnesses of the outer and inner wires 4a and 4b, a desired DC tilt can be obtained so as to compensate (i.e. make zero) the tilt of the optical disc 10, i.e. so as to produce a DC tilt angle (θ2) of the objective lens 3 which is substantially equal to a tilt angle (θ1) of the optical disc 10, making and maintaining the center or optical axis of the objective lens 3 substantially perpendicular to the signal recording surface 10a of the optical disc 10.

As described in the foregoing, the provision of the difference in stiffness between the outer circumferential side wires 4a and the inner circumferential side wires 4b (stiffness of the former being lower than the latter) in the optical pickup device 1 of the present embodiment makes it possible to automatically produce a DC tilt of the objective lens 3 corresponding to the tilt or disc tilt of the optical disc 10 so as to automatically compensate the disc tilt of the optical disc 10 e.g. by simply differentiating the stiffness of the outer and inner wires 4a and 4b (e.g. using different materials for the wires 4a and 4b) without differentiating the size (length) of the outer and inner wires 4a and 4b.

Thus, with the simple structure, the optical pickup device 1 of the present embodiment can reduce the tilt (relative tilt) between the optical disc 10 and the objective lens 3 when recording (writing) or reproducing (reading) information signals on or from the optical disc 10, so as to reduce jitter and improve recording and reproduction performance of the optical pickup device 1, thereby enabling recording and reproduction of good quality images. Additional advantages of the present embodiment are that conventional optical pickup devices may be able to be easily improved by simply changing the stiffness or material of suspension wires, and that the substantially same effective length (L1=L2) of the outer and inner wires 4a and 4b makes it possible to produce a DC tilt of the lens holder 2 (objective lens 3) with a good mechanical balance between the outer and inner circumferential sides 2a, 2b of the lens holder 2, making it easier to maintain or restore the perpendicular relationship between the signal recording surface 10a of the optical disc 10 and the optical axis of the objective lens 3.

It is to be noted that the present invention is not limited to the above embodiment, and various modifications are possible within the spirit and scope of the present invention. For example, each of the number of outer circumferential side wires 4a and that of inner outer circumferential side wires 4b shown in the first and second embodiments is two. However, the number of outer and inner wires 4a and 4b can be one (single wire), three or more. It is also possible that both length and stiffness of the outer wires 4a can be different from those of the inner wires 4b, whereby the sensitivity of the tilt rotation or DC tilt of the lens holder 2 (objective lens 3) can be increased.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

What is claimed is:

1. An optical pickup device comprising:
an objective lens;
a lens holder for holding the objective lens at a position facing a signal recording surface of an optical disc, the lens holder having an outer circumferential side and an inner circumferential side relative to the optical disc;
a suspension wire (hereafter referred to as “outer wire”) fixed at one end thereof to the outer circumferential side of the lens holder and a suspension wire (hereafter referred to as “inner wire”) fixed at one end thereof to the inner circumferential side of the lens holder, the outer and inner wires extending substantially in parallel to the signal recording surface of the optical disc,
a suspension holder for supporting the other ends of the outer and inner wires so as to cantilever the lens holder, and
a magnetic drive circuit for driving the lens holder with the objective lens in a focusing direction,
wherein the outer wire has a longer effective length than that of the inner wire, whereby when the lens holder with the objective lens is moved in the focusing direction by the magnetic drive circuit, the movement of the lens holder causes the outer wire to move more than the inner wire so as to tilt the objective lens at a tilt angle corresponding to the amount of movement of the lens holder.

2. The optical pickup device according to claim 1, wherein the one end of the outer wire fixed to the outer circumferential side of the lens holder is positioned at a position farther from the suspension holder than a position at which the one end of the inner wire fixed to the inner circumferential side of the lens holder is positioned.

3. An optical pickup device comprising:
an objective lens;
a lens holder for holding the objective lens at a position facing a signal recording surface of an optical disc, the lens holder having an outer circumferential side and an inner circumferential side relative to the optical disc;
a suspension wire (hereafter referred to as “outer wire”) fixed at one end thereof to the outer circumferential side of the lens holder and a suspension wire (hereafter referred to as “inner wire”) fixed at one end thereof to the inner circumferential side of the lens holder, the outer and inner wires extending substantially in parallel to the signal recording surface of the optical disc,
a suspension holder for supporting the other ends of the outer and inner wires so as to cantilever the lens holder, and
a magnetic drive circuit for driving the lens holder with the objective lens in a focusing direction,
wherein the outer wire has a lower stiffness than the inner wire, whereby when the lens holder with the objective lens is moved in the focusing direction by the magnetic drive circuit, the movement of the lens holder causes the outer wire to move more than the inner wire so as to tilt the objective lens at a tilt angle corresponding to the amount of movement of the lens holder.

4. The optical pickup device according to claim 3, wherein the outer wire is made of a material different from a material of which the inner wire is made.

5. The optical pickup device according to claim 3, wherein the outer wire has an effective length substantially the same as that of the inner wire.

6. The optical pickup device according to claim 3, wherein the one end of the outer wire fixed to the outer circumferential side of the lens holder and the one end of the inner wire fixed to the inner circumferential side of the lens holder are equidistant from the suspension holder.
